(19) United States
(12) Patent Application Publication
(10) Pub. No.: US 2017/0004616 A1
(43) Pub. Date: Jan. 5, 2017

(54) VISUAL INSPECTION SUPPORT APPARATUS, VISUAL INSPECTION SUPPORT METHOD AND PROGRAM

(71) Applicant: FUJITSU LIMITED, Kawasaki-shi (JP)

(72) Inventor: Hiroaki OKAMOTO, Atsugi (JP)

(73) Assignee: FUJITSU LIMITED, Kawasali-shi (JP)

(21) Appl. No.: 15/266,663

(22) Filed: Sep. 15, 2016

Related U.S. Application Data
(63) Continuation of application No. PCT/JP2014/060227, filed on Apr. 8, 2014.

(51) Int. Cl. G06T 7/00; G06F 3/14; G01N 21/88

(52) U.S. Cl. CPC G06T 7/0004; G01N 21/8851; G06F 3/14; G01N 2021/8893; G06T 2207/30196

(57) ABSTRACT

An visual inspection support apparatus includes a camera configured to obtain a plurality of different images capturing one or more visual inspection target objects; an action information acquisition apparatus configured to obtain action information of a visual inspection worker; and a processing device configured to determine an activity level of the visual inspection worker based on the action information, and change a way of displaying the images based on a determination result of the activity level of the visual inspection worker.

### CROSS-REFERENCE TO RELATED APPLICATIONS

This is a continuation of International Application No. PCT/JP2014/060227, filed on Apr. 8, 2014, the entire contents of which are incorporated herein by reference.

### FIELD

The disclosure is related to a visual inspection support apparatus, a visual inspection support method and a program.

### BACKGROUND

A visual inspection apparatus is known from Japanese Laid-open Patent Publication No. 2009-150866, in which an image inspection result based on an image capturing of a part to be inspected and analysis of images are superposed on a field of vision of an inspector who visually inspects the part such that the image inspection result is displayed at a position corresponding to a position of an image checked by the inspector.

In the case where a visual inspection worker visually checks an inspection image to inspect the presence or absence of a defect in a visual inspection target object, etc., it is effective to successively display a plurality of inspection images for the visual inspection worker. However, the successively displayed inspection images force the visual inspection worker to visually check the inspection images successively, which may reduce an activity level of the visual inspection worker, such as a concentration level, etc., during the inspection operation.

### SUMMARY

According to an aspect of the disclosure, a visual inspection support apparatus is provided, the visual inspection support apparatus includes:

a camera configured to obtain a plurality of different images capturing one or more visual inspection target objects;

an action information acquisition apparatus configured to obtain action information of a visual inspection worker; and

a processing device configured to determine an activity level of the visual inspection worker based on the action information, and change a way of displaying the images based on a determination result of the activity level of the visual inspection worker.

The object and advantages of the embodiment will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF DRAWINGS

FIG. 1 is a diagram illustrating an example of an inspection system including a visual inspection support apparatus.

FIG. 2 is a diagram illustrating an example of a hardware resource configuration of a processing device.

FIG. 3 is a diagram illustrating an example of a function configuration of the processing device.

FIG. 4 is a flowchart illustrating an example of an inspection image acquisition process by the visual inspection support apparatus.

FIG. 5 is a flowchart illustrating an example of an inspection image display process by the processing device of the visual inspection support apparatus.

FIGS. 6A and 6B are diagrams explaining a display order for a series of inspection images.

FIGS. 7A and 7B are diagrams explaining a display timing for a series of inspection images.

FIGS. 8A through 8C are diagrams explaining a display timing for a series of inspection images.

FIGS. 9A and 9B are diagrams explaining an estimation way of an activity level based on a reaction time.

FIGS. 10A and 10B are diagrams explaining an estimation way of an activity level based on a motion of a vision line position.

FIGS. 11A and 11B are diagrams illustrating an example of a change in a parameter indicative of the activity level of the visual inspection worker.

FIGS. 12A and 12B are diagrams explaining an example of a conversion process of the inspection image according to a feature portion of a part.

FIGS. 13A and 13B are diagrams explaining another example of a conversion process of the inspection image according to a feature portion of a part.

### DESCRIPTION OF EMBODIMENTS

In the following, embodiments will be described with reference to the accompanying drawings.

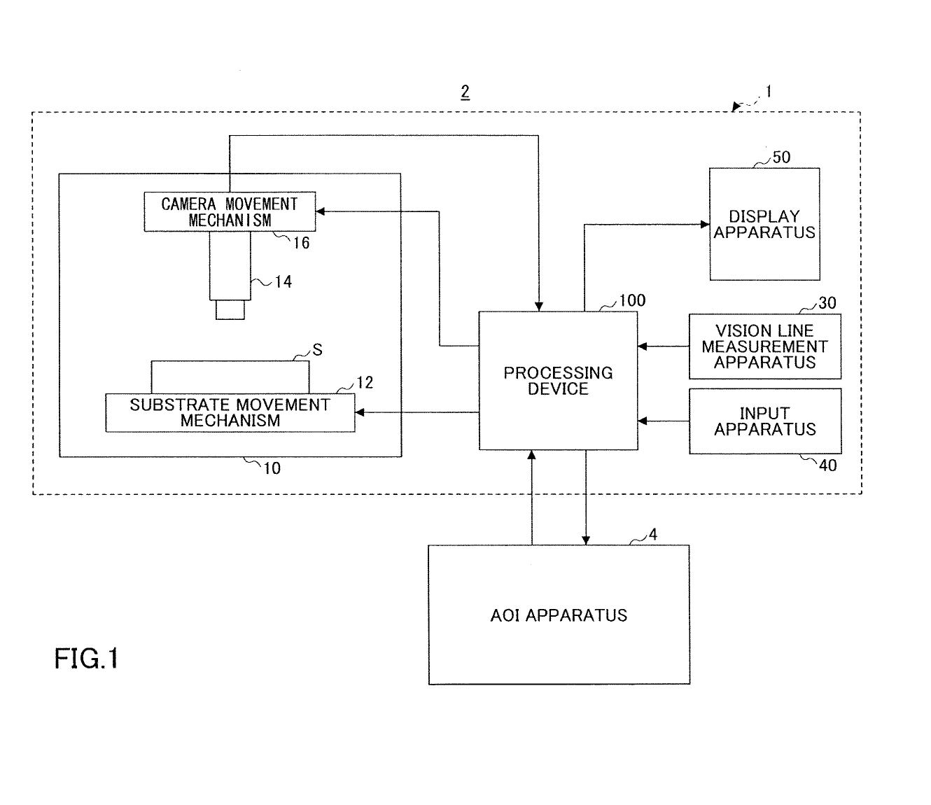

FIG. 1 is a diagram illustrating an example of an inspection system 2 including a visual inspection support apparatus 1. The inspection system 2 includes the visual inspection support apparatus 1 and an AOI (Automated Optical Inspection) apparatus 4.

The visual inspection support apparatus 1 includes an image capture apparatus 10, a vision line measurement apparatus 30, an input apparatus 40, a display apparatus 50, and a processing device 100.

The image capture apparatus 10 includes a substrate movement mechanism 12, a camera 14, and a camera movement mechanism 16.

The substrate movement mechanism 12, under control by the processing device 100, moves a substrate S on a stage, for example, in one, two or three axis directions.

The camera 14 captures an image of the substrate S under the control by the processing device 100. In the example illustrated in FIG. 1, the camera 14 captures the image of the substrate S from a top side of the substrate S. The images (inspection images) thus obtained are supplies to the processing device 100.

The camera movement mechanism 16, under the control by the processing device 100, moves the camera 14 (the position of a camera head), for example, in one, two or three axis directions. It is noted that the camera movement mechanism 16 may include a mechanism for changing an optical axis direction (orientation) of the camera 14.

The vision line measurement apparatus 30 includes a camera, for example, to obtain an image of a face (eyes) of the visual inspection worker.

The input apparatus 40 accepts an input from the visual inspection worker to supply input information to the processing device 100. The input apparatus 40 may include a keyboard including cursor keys, number keys and function keys, a mouse, a touch pad or the like. Further, the input apparatus 40 may include a speech recognition apparatus. The visual inspection worker inputs visual inspection results, etc., via the input apparatus 40.

The display apparatus 50 is such as a CRT (Cathode-Ray Tube) display, a liquid crystal display, etc. The visual inspection worker performs a visual inspection by visually checking the instruction image displayed on the display apparatus 50.

The processing device 100 performs the control of the operation of the image capture apparatus 10, a process of the vision line information obtained from the vision line measurement apparatus 30, a display process of the inspection images on the display apparatus 50, etc. The function of the processing device 100 is described hereinafter. Further, the processing device 100 may be implemented by a plurality of processing devices. Further, a part of the function of the processing device 100 may be implemented by the vision line measurement apparatus 30 and/or the display apparatus 50.

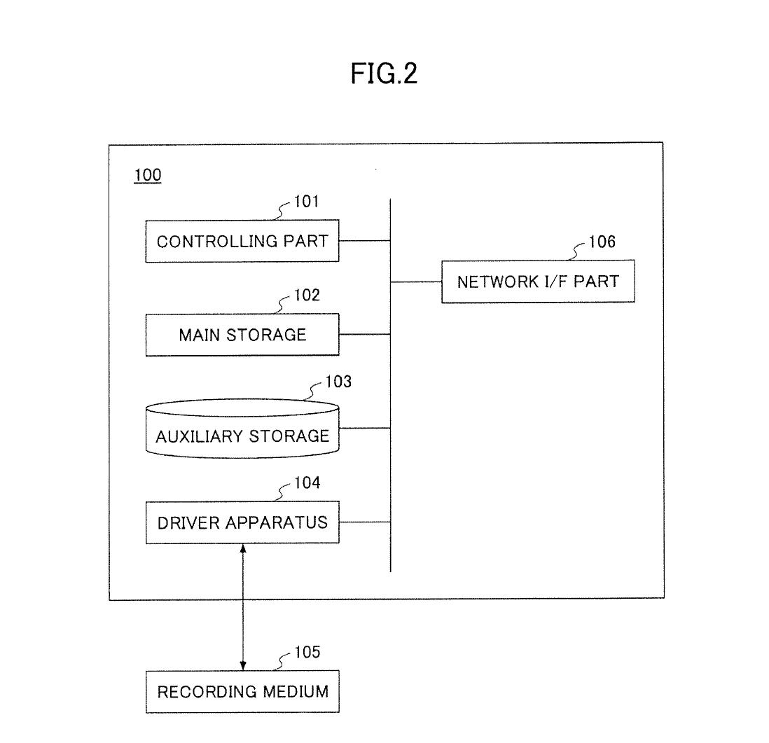

FIG. 2 is a diagram illustrating an example of a hardware resource configuration of the processing device 100.

As illustrated in FIG. 2, the processing device 100 includes a controlling part 101, a main storage 102, an auxiliary storage 103, a driver apparatus 104, and a network I/F part 106.

The controlling part 101 is an arithmetical unit which executes programs stored in the main storage 102 or the auxiliary storage 103. The controlling part 101 receives the data from the input apparatus 40 or the storage and outputs to the storage after performing the calculation or processing.

The main storage 102 is a ROM (Read Only Memory), a RAM (Random Access Memory) or the like. The main storage 101 stores or temporarily stores programs such as an OS, which is fundamental software the controlling part 801 executes, or application software or data.

The auxiliary storage 103 is a HDD (Hard Disk Drive) or the like. The auxiliary storage 103 stores data related to the application software, etc.

The driver apparatus 104 reads the programs from a recording medium 105, for example, a flexible disk, and installs the programs in the storage.

The recording medium 105 stores a predetermined program. The program stored in the recording medium 105 is installed in the processing device 100 via the driver apparatus 104. The installed program can be executed by the processing device 100.

The network I/F part 106 is an interface between peripherals with communication capabilities, which are connected via a network constructed by data transmission lines such as wired and/or wireless transmission lines, and the processing device 100.

It is noted that, in the example illustrated in FIG. 2, the processes described hereinafter can be implemented by causing the processing device 100 to execute one or more programs. Further, it is also possible to store one or more programs in the recording medium 105, and cause the processing device 100 to read the programs stored in the recording medium 105 to implement the processes described hereinafter. It is noted that the recording medium 105 may be of any type. For example, the recording medium 105 may include a recording medium for optically, electrically or magnetically storing information, such as a CD-ROM, a flexible disk, a magneto-optical disk, and a semiconductor memory for electrically storing information, such as a ROM, a flash memory. It is noted that carrier waves are not included in a concept of the term “recording medium”.

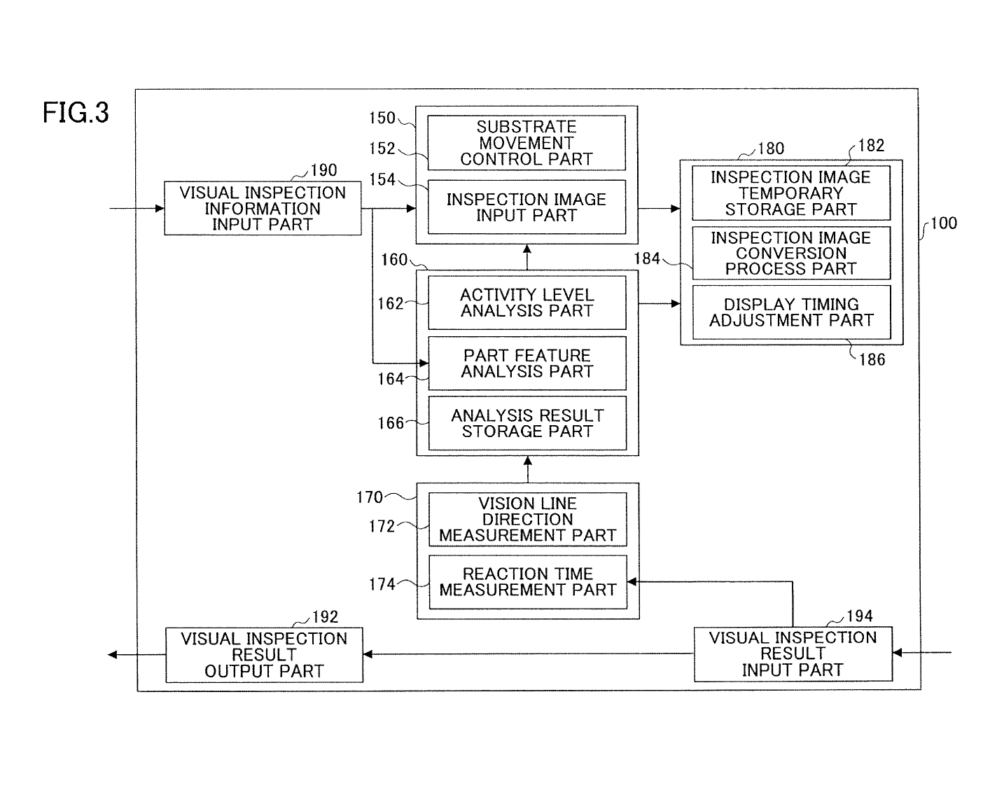

FIG. 3 is a diagram illustrating an example of a function configuration of the processing device 100.

The processing device 100 includes an image capture process part 150, an inspection image display control part 160, a worker information acquisition part 170, an inspection image display part 180, a visual inspection information input part 190, a visual inspection result output part 192, and a visual inspection result input part 194.

The image capture process part 150 includes a substrate movement control part 152 for controlling the substrate movement mechanism 12 and the camera movement mechanism 16, and an inspection image input part 154 to which the inspection images from the camera 14 are input.

The inspection image display control part 160 includes an activity level analysis part 162, a part feature analysis part 164, and an analysis result storage part 166.

The worker information acquisition part 170 includes a vision line direction measurement part 172 and a reaction time measurement part 174.

The vision line direction measurement part 172 detects a line of vision (sight) of the visual inspection worker based on the images from the vision line measurement apparatus 30. A way of detecting the line of vision of the visual inspection worker is arbitrary. For example, in the case where the vision line measurement apparatus 30 includes a camera and a near-infrared LED, a cornea reflection method may be used in which pupil and cornea reflection are detected when the face of the visual inspection worker is illuminated by near-infrared light, and then the line of vision is calculated based on a positional relationship between the pupil and the cornea. The method utilizes a fact that the position of the pupil is changed according to the direction of the line of vision, while the position of the cornea does not depend on the direction of the line of vision. If the face is illuminated by the near-infrared light, the cornea reflection which can be a reference point in the eye is generated, which increases measurement accuracy in comparison with a measurement way that uses only a camera. It is noted that, in this case, the near-infrared LED may be provided in a frame of the display apparatus 50 together with the camera of the vision line measurement apparatus 30, for example.

The reaction time measurement part 174 measures a time (reaction time) which starts at a timing when the inspection image is displayed and ends at a timing when the visual inspection worker inputs the inspection result with respect to the displayed inspection image via the input apparatus 40.

The inspection image display part 180 includes an inspection image temporary storage part 182, an inspection image conversion process part 184, and a display timing adjustment part 186.

The inspection image temporary storage part 182 temporarily stores a series of the inspection images. The inspection image conversion process part 184 performs adjustment of a contrast of the inspection images, masking the inspection images, scaling up/down the inspection images, etc. The display timing adjustment part 186 adjusts the display timing of the inspection image.

The visual inspection information input part 190 has part information, such as part numbers, part positions, etc., input therein from the AOI apparatus 4. The visual inspection result output part 192 outputs the visual inspection result input by the visual inspection worker to the outside (a post-processing device 100, for example). The visual inspection result input part 194 processes the visual inspection result input by the visual inspection worker.

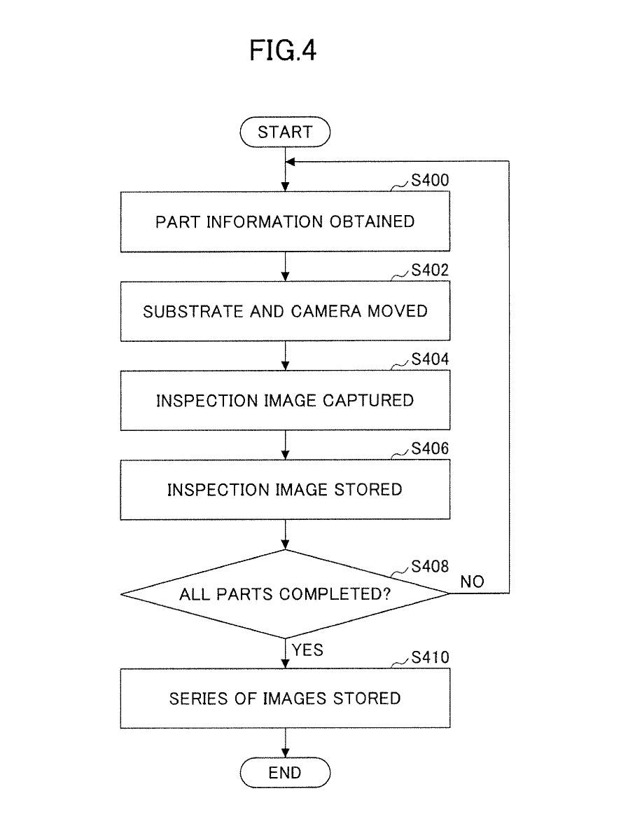

FIG. 4 is a flowchart illustrating an example of an inspection image acquisition process by the visual inspection support apparatus 1.

In step S400, the part information (the part numbers, part positions, etc.) related to the inspection target parts to be visually inspected is input from the AOI apparatus 4 to the visual inspection information input part 190.

In step S402, the substrate movement control part 152 controls, based on the part information obtained in step S400, the substrate movement mechanism 12 and the camera movement mechanism 16 to adjust the positional relationship between the substrate S and the camera 14.

In step S402, the camera 14 captures an image of the substrate S (and the part(s) installed thereon).

In step S406, the inspection image input part 154 holds the inspection image obtained in step S404.

In step S408, the image capture process part 150 determines whether images of all the inspection target parts on the substrate S have been captured. In other words, the image capture process part 150 determines whether all the inspection images to be obtained with respect to the substrate S in question have been obtained. If the images of all the parts have been captured, a series of the inspection images thus obtained with respect to the substrate S in question is stored in the inspection image temporary storage part 182.

According to the process illustrated in FIG. 4, the inspection images are obtained with the camera 14 with respect to all the parts on the substrate S. It is noted that the inspection image is not necessarily only one for a single part, and thus one or more inspection images may be obtained for a single part, or a single (common) inspection image may be obtained for two or more parts. For example, images of a certain part may be captured from a plurality of directions. Further, the inspection images may be obtained with respect to only a part of the parts on the substrate S. Further, a capturing order in which the parts on the substrate S are imaged with the camera 14 may be fixed. In this case, the capturing order in which the parts on the substrate S are imaged may be determined such that the movement amount of the camera 14 between the capturing points becomes minimum.

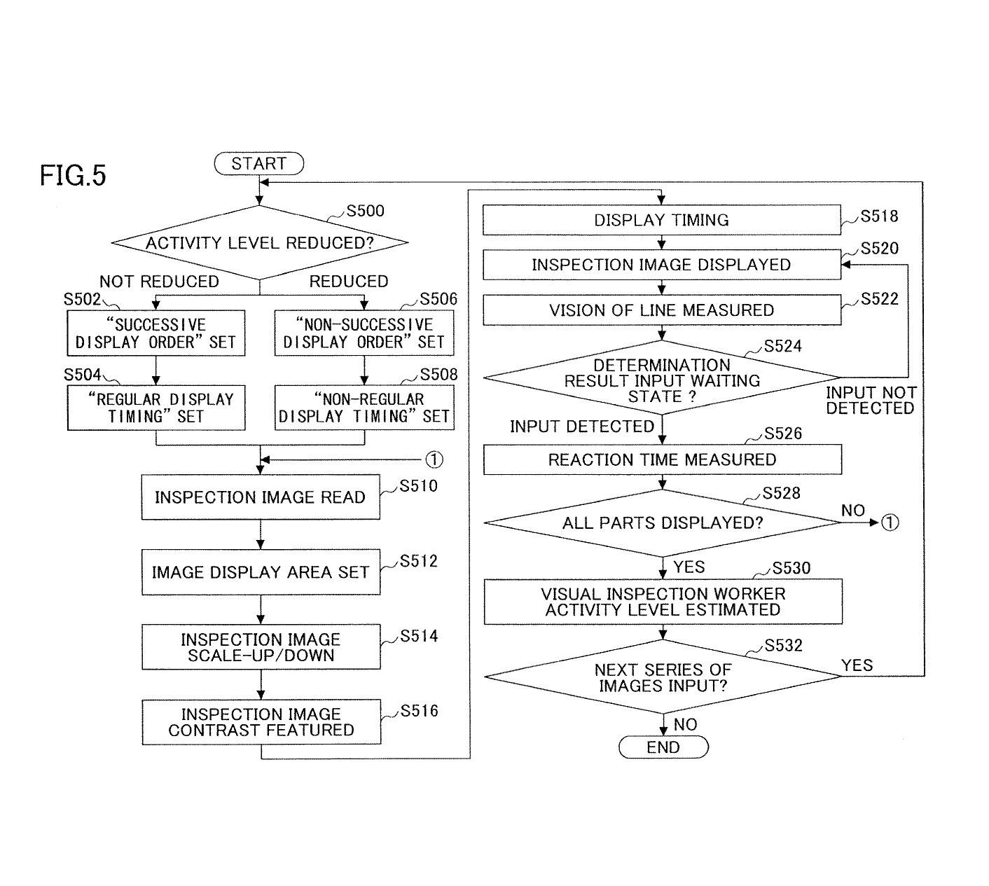

FIG. 5 is a flowchart illustrating an example of an inspection image display process by the processing device 100 of the visual inspection support apparatus 1. It is noted that the process illustrated in FIG. 5 may be performed in real time and in synchronization with the process illustrated in FIG. 4. Alternatively, the process illustrated in FIG. 5 may be in synchronization with the process illustrated in FIG. 4 such that the process illustrated in FIG. 5 is performed with a delay of predetermined time with respect to the process illustrated in FIG. 4, or such that the process illustrated in FIG. 5 is performed after the process illustrated in FIG. 4 has been completed.

In step S500, the activity level analysis part 162 determines, based on the analysis result in the analysis result storage part 166, whether the activity level of the visual inspection worker has been reduced. The activity level of the visual inspection worker is an index indicative of a concentration level, an arousal level of the visual inspection worker, etc. The reduced activity level of the visual inspection worker means that the concentration level or the arousal level of the visual inspection worker is reduced. Further, in general, the activity level of the visual inspection worker is reduced as a fatigue level of the visual inspection worker increases. A way of calculating the activity level of the visual inspection worker is arbitrary, and some examples thereof are described hereinafter. If the activity level of the visual inspection worker is reduced, the process routine goes to step S506, otherwise (i.e., the activity level of the visual inspection worker is not reduced) the process routine goes to step S502.

In step S502, the display timing adjustment part 186 sets the display order of the series of the inspection images to “successive display order”. The “successive display order” may be such that the inspection images related to the same parts on the substrate S are successively displayed. It is noted that the same parts indicate the parts whose part numbers are the same, but may additionally include the same types of the parts.

In step S504, the display timing adjustment part 186 sets the display timing for the series of the inspection images to “regular display timing”. The “regular display timing” may be such that the series of the inspection images are successively displayed with a constant interval.

In step S506, the display timing adjustment part 186 sets the display order of the series of the inspection images to “non-successive display order”. The “non-successive display order” may be arbitrary order different from the “successive display order” described above. For example, the “non-successive display order” corresponds to the capturing order of the series of the inspection images, or may be a randomly determined order.

In step S508, the display timing adjustment part 186 sets the display timing for the series of the inspection images to “non-regular display timing”. The “non-regular display timing” may be such that the series of the inspection images are successively displayed with a randomly determined interval or an irregular interval.

In step S510, the inspection image conversion process part 184 reads one inspection image, according to the display order determined in step S502 or step S506, among the series of the inspection images stored in the inspection image temporary storage part 182.

In step S512, the inspection image conversion process part 184 sets an image display area (display region) with respect to the read inspection image. The image display area may be a part of the inspection image or the inspection image as a whole. The image display area may be determined in advance on an inspection image basis (on a part basis). Alternatively, the image display area may be determined based on the vision line information of the visual inspection worker, etc., as described hereinafter.

In step S514, the inspection image conversion process part 184 performs a scale-up/down process with respect to the read inspection image. The scale-up/down process may be optional such that it is performed if necessary.

In step S516, the inspection image conversion process part 184 performs a contrast featuring process with respect to the read inspection image. The contrast featuring process may be optional such that it is performed if necessary.

In step S518, the display timing adjustment part 186 adjusts the display timing of the read inspection image according to the display order determined in step S504 or step S508. For example, the display timing adjustment part 186 adjusts the display timing of the read inspection image based on a brank time (i.e., an interval) before displaying the read inspection image. It is noted that the interval for the first image of the series of the inspection images may be a minimum value.

In step S520, the display timing adjustment part 186 displays (outputs) the inspection image on the display apparatus 50. The visual inspection worker performs the visual inspection by visually checking the instruction image displayed on the display apparatus 50. When the visual inspection worker has completed the visual inspection with respect to the inspection image currently displayed, the visual inspection worker inputs the visual inspection result (the presence or absence of a defect(s), for example) via the input apparatus 40.

In step S522, the vision line direction measurement part 172 detects, based on information from the vision line measurement apparatus 30, a vision line position of line of the visual inspection worker.

In step S524, the display timing adjustment part 186 determines whether the visual inspection result (determination result) from the visual inspection worker has been input. In other words, it is a waiting state for the input of the visual inspection result from the visual inspection worker. If the visual inspection result from the visual inspection worker has been input, the process routine goes to step S526, otherwise the process routine returns to step S520. In this way, once one inspection image has been displayed, the displayed state of the inspection image is maintained until the input of the visual inspection result with respect to the displayed inspection image from the visual inspection worker. During this period, the vision line direction measurement part 172 continues to detect the vision line position of the visual inspection worker in step S522. With this arrangement, the motion (trajectory) of the vision line position of the visual inspection worker during the visual inspection can be obtained.

In step S526, the reaction time measurement part 174 measures the time (reaction time) which starts at a timing when the inspection image is displayed and ends at a timing when the visual inspection worker inputs the visual inspection result with respect to the displayed inspection image. Specifically, the reaction time measurement part 174 measures the time from the display start timing of the current inspection image to the input timing of the visual inspection result for the current inspection image.

In step S528, the activity level analysis part 162 determines whether images of all the inspection target parts on the substrate S have been displayed. In other words, the inspection image display control part 160 determines whether the series of the inspection images have been displayed. If the series of the inspection images have been displayed, the process routine goes to step S530, otherwise the process routine returns to step S510. In this way, until the series of the inspection images have been displayed, the processes of step S510 through step S526 are performed repeatedly.

In step S530, the activity level analysis part 162 analyzes the activity level of the visual inspection worker based on action information of the visual inspection worker during a display period for the current series of the inspection images. The action information of the visual inspection worker includes a detection result of the motion of the vision line position of the visual inspection worker during the visual inspection with respect to the current series of the inspection images, and the measurement result of the reaction times of the visual inspection worker with respect to the current series of the inspection images. The reaction times of the visual inspection worker each are related to the corresponding one of the inspection images in the current series of the inspection images. This is because the activity level of the visual inspection worker has a correlation with the motion of the vision line position of the visual inspection worker during the visual inspection, and the reaction times of the visual inspection worker. In general, the quicker the motion of the vision line position of the visual inspection worker during the visual inspection is, the more the cases where the activity level of the visual inspection worker is high may be. Further, in general, the shorter the reaction times of the visual inspection worker are, the more the cases where the activity level of the visual inspection worker is high may be. The activity level analysis part 162 may utilize such tendencies to analyze the activity level of the visual inspection worker. The activity level analysis part 162 stores the analysis result of the activity level thus obtained (a value of the activity level, for example) in the analysis result storage part 166.

It is noted that, in step S530, the part feature analysis part 164 may analyze the feature portion of the part based on the detection result of the vision line position of the visual inspection worker obtained in step S524. This is because, if the part includes the feature portion (an important portion for the inspection), the visual inspection worker tends to carefully check the feature portion, in particular. The analysis result of the part feature analysis part 164 may be utilized in the processes of step S512 through step S516. For example, in step S512, the inspection image conversion process part 184 sets the image display area such that the image display area includes the feature portion detected by the part feature analysis part 164 at substantially a center thereof. Further, the inspection image conversion process part 184 may change a direction of a view of the inspection image such that the feature portion detected by the part feature analysis part 164 becomes visible from a front side. Further, in step S514, the inspection image conversion process part 184 may enlarge the feature portion detected by the part feature analysis part 164. Further, in step S514, the inspection image conversion process part 184 may feature the image area of the feature portion detected by the part feature analysis part 164 with respect to other image areas in terms of the contrast with respect to the brightness or the color. Further, in step S514, the inspection image conversion process part 184 may mask the other image areas other than the image area of the feature portion detected by the part feature analysis part 164 so that the visual inspection worker naturally can concentrate on checking only the image area of the feature portion detected by the part feature analysis part 164.

In step S532, the activity level analysis part 162 determines whether there is a next series of the inspection images. Specifically, the activity level analysis part 162 determines whether a series of the inspection images with respect to a new substrate S has been input. If a series of the inspection images with respect to a new substrate S has been input, the process routine returns to step S500. In this case, in the determination process of step S500 with respect to the series of the inspection images for the new substrate S, the analysis result obtained at this time is to be utilized. On the other hand, if a series of the inspection images with respect to a new substrate S has not been input, it is determined that the visual inspection has been completed, and thus the process routine ends.

According to the process illustrated in FIG. 5, the activity level of the visual inspection worker is estimated based on the action information of the visual inspection worker during the visual inspection, and the display order and the display timing for the series of the inspection images are varied according to the estimated activity level of the visual inspection worker. With this arrangement, it becomes possible to change the display order and the display timing for the series of the inspection images to increase the activity level of the visual inspection worker when the activity level of the visual inspection worker is reduced. As a result of this, it becomes possible to keep the increased activity level of the visual inspection worker for longer time, which enables increasing the accuracy of the visual inspection.

It is noted that the process illustrated in FIG. 5 is performed on a series of inspection images, which in turn is obtained on a substrate S basis; however, the process may be performed on a series of inspection images, which in turn is obtained one for more than two substrates S. Alternatively, the process illustrated in FIG. 5 may be performed such that the series of the inspection images for a single substrate S is divided into two or more, and the process illustrated in FIG. 5 may be performed for each of the divided ones of the series of the inspection images.

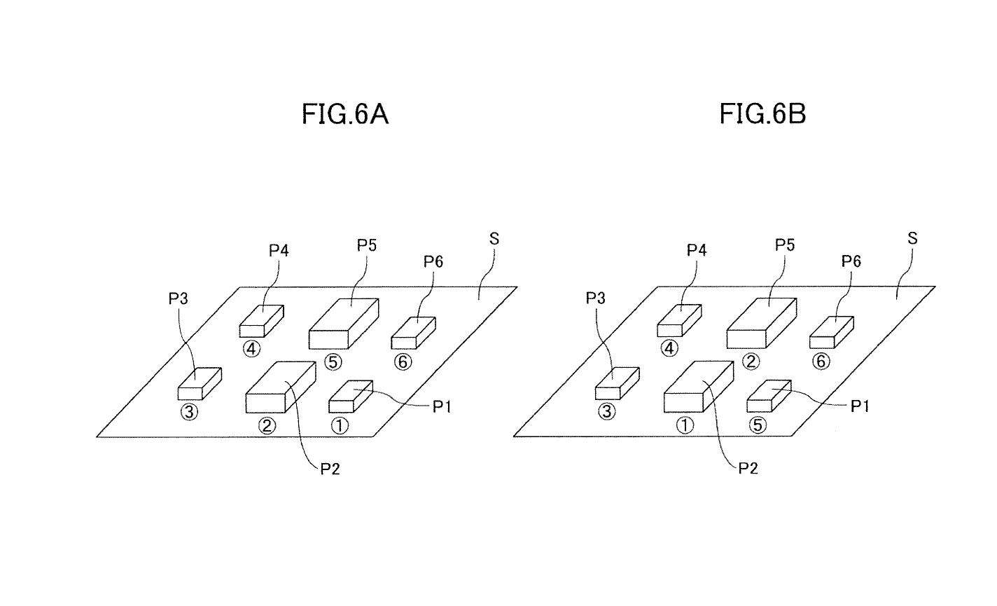

FIGS. 6A and 6B are diagrams explaining the display order for the series of the inspection images, in which FIG. 6A illustrates an example and FIG. 6B illustrates another example.

In the example illustrated in FIGS. 6A and 6B, six parts P1 through P6 are installed on the substrate S. It is noted that the substrate S may be arbitrary, such as a printed circuit board, etc. The parts P1 through P6 may be arbitrary, such as an LSI (Large-Scale Integration), a damping resistor, etc. Installation type of the parts P1 through P6 may be also arbitrary, such as an IMD (Insert Mount Device), a SMD (Surface Mount Device), a press-fitting type, etc. In the example illustrated in FIGS. 6A and 6B, as an example, the part P1 and the part P6 are the same, the part P2 and the part P5 are the same, and the part P3 and the part P4 are the same. In FIGS. 6A and 6B, numerals inserted in circle marks adjacent to the corresponding part P1 and the part P6 indicate the display order. Here, as an example, it is assumed that the inspection images are obtained for the part P1 and the part P6, respectively, and thus the series of the inspection images includes six images in total.

In example illustrated in FIG. 6A, the display order of the respective part P1 and the part P6 corresponds to the capturing order. Specifically, in the example illustrated in FIG. 6A, the capturing order of the part P1 and the part P6 is determined such that the movement amount of the camera 14 between the capturing points becomes minimum. Specifically, the images of the part P1 and the part P6 are captured from the part P1 to the part P6 in the order, and the respective inspection images of the part P1 and the part P6 are displayed in the capturing order. Such a display order may be used as “non-successive display order” set in step S506. With this arrangement, when the activity level of the visual inspection worker is detected, it becomes possible to give an appropriate stimulation to the visual inspection worker by setting the display order of the inspection images to “non-successive display order” so as to avoid excessive monotony. It is noted that the display order corresponds to the capturing order with the camera 14 (i.e., the order of moving the stage), which enables displaying the inspection images in real time and in synchronization with the capturing with the camera 14.

In the example illustrated in FIG. 6B, the part P2 and the part P5 are the same and are given the first and second display orders, respectively, such that the inspection images of the same parts are displayed successively. Further, the part P3 and the part P4 are the same and are given the third and fourth display orders, respectively, such that the inspection images of the same parts are displayed successively. Further, the part P1 and the part P6 are the same and are given the fifth and sixth display orders, respectively, such that the inspection images of the same parts are displayed successively. In this way, in the example illustrated in FIG. 6B, the display order of the inspection images is changed from the capturing order of the inspection images such that the inspection images of the same parts are displayed successively. Such a display order may be used as “successive display order” set in step S502. When the activity level of the visual inspection worker is high, using such a “successive display order” makes it easier for the visual inspection worker to detect the defect because the inspections of the same parts are successive. This is because, when the visual inspection worker visually distinguishes the difference between a normal part and the defect part, successively inspecting the same parts is better in terms of easily finding out the defect.

On the other hand, if the inspection images of the same part are successively displayed for a long time, there may be a case where the activity level of the visual inspection worker is reduced. For this reason, when the reduction in the activity level of the visual inspection worker is detected, the display order is switched to the “non-successive display order” such as illustrated in FIG. 6A to promote the attention.

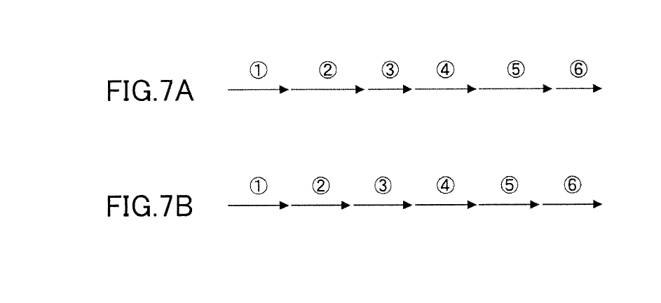

FIGS. 7A and 7B are diagrams explaining a display timing for the series of the inspection images in which FIG. 7A illustrates an example of an interval (non-display period) in displaying the respective inspection images, and FIG. 7B illustrates another example of the interval in displaying the respective inspection images. In FIGS. 7A and 7B, arrows indicate intervals, and the length of the arrow schematically indicate the length of the interval. In FIGS. 7A and 7B, numerals inserted in circle marks indicate the intervals. Here, as an example, it is assumed that the inspection images are obtained for seven parts, respectively, and thus the series of the inspection images includes seven images in total. Thus, the number of the intervals for the series of the inspection images is six.

In the example illustrated in FIG. 7A, the intervals for the series of the inspection images are not constant. For example, the intervals correspond to intervals (i.e., capturing intervals) at the time of capturing the inspection images with the camera 14. The capturing intervals are not constant correspondingly, if the movement amount of the camera 14 is not constant as illustrated in FIGS. 6A and 6B. Such a display timing may be used as “non-regular display timing” set in step S508. With this arrangement, when the reduction in the activity level of the visual inspection worker is detected, it becomes possible to give attention to the visual inspection worker by setting the display timing for the inspection images to “non-regular display timing” so as to avoid excessive monotony. It is noted that the intervals related to the display timing correspond to the capturing intervals with the camera 14, which enables displaying the inspection images in real time and in synchronization with the capturing with the camera 14.

In the example illustrated in FIG. 7B, the intervals for the series of the inspection images are constant. Such a display timing may be used as “regular display timing” set in step S504. Here, even in visually checking the same parts in succession, displaying rhythmically with a constant timing may make it easier for the visual inspection workers to detect the defect with increased comfort, in comprising with displaying randomly. Thus, when the activity level of the visual inspection worker is high, it can be expected that using such a “regular display timing” increase the comfort of the visual inspection workers and the inspection accuracy. It is noted that the “regular display timing” does not correspond the capturing intervals with the camera 14. Thus, if such a “regular display timing” is used, the captured inspection images may be stored, and after the series of the inspection images have been obtained, the inspection images may be displayed with a constant interval.

On the other hand, if the inspection images are displayed with the similar rhythm for a long time, there may be a case where the activity level of the visual inspection worker is reduced. For this reason, when the reduction in the activity level of the visual inspection worker is detected, the display timing is switched to the “non-regular display timing” such as illustrated in FIG. 7A to promote the increase of the activity level. As an example of such a non-regular display timing, a constant interval of 0.8 sec is set and the interval is changed within plus and minus 0.3 sec to implement the non-regular display timing.

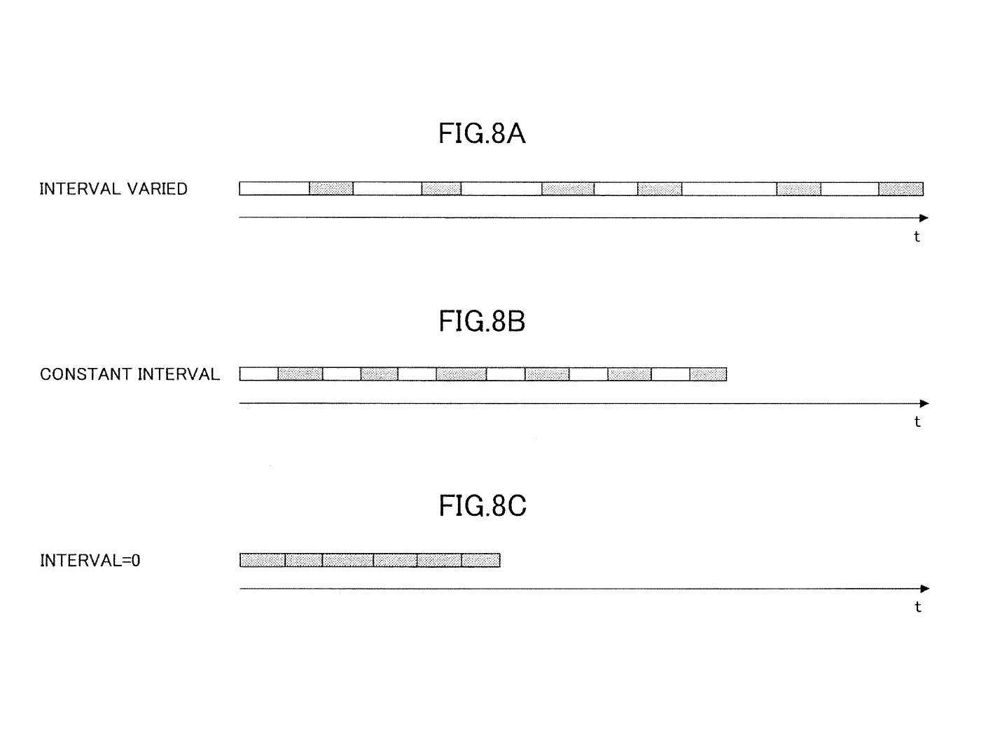

FIGS. 8A through 8C are diagrams explaining a display timing for a series of inspection images, in which FIG. 8A illustrates an example of a case where the intervals are different, FIG. 8B illustrates a case where the intervals are the same, and FIG. 8C illustrates a case where the intervals are 0. In FIGS. 8A through 8C, hatched portions indicate display periods of the inspection images, and white-out portions indicate the intervals. Here, as an example, the series of the inspection images includes six images in total.

The timing illustrated in FIG. 8A corresponds to the “non-regular display timing” illustrated in FIG. 7A. It is noted that the timing of ending the display period of the inspection image corresponds to the input timing of the inspection result from the visual inspection worker with respect to the inspection image in question, as described above (see step S524 in FIG. 5).

The timing illustrated in FIG. 8B corresponds to the “regular display timing” illustrated in FIG. 7B. The timing illustrated in FIG. 8C corresponds to another example of the “regular display timing” illustrated in FIG. 7B.

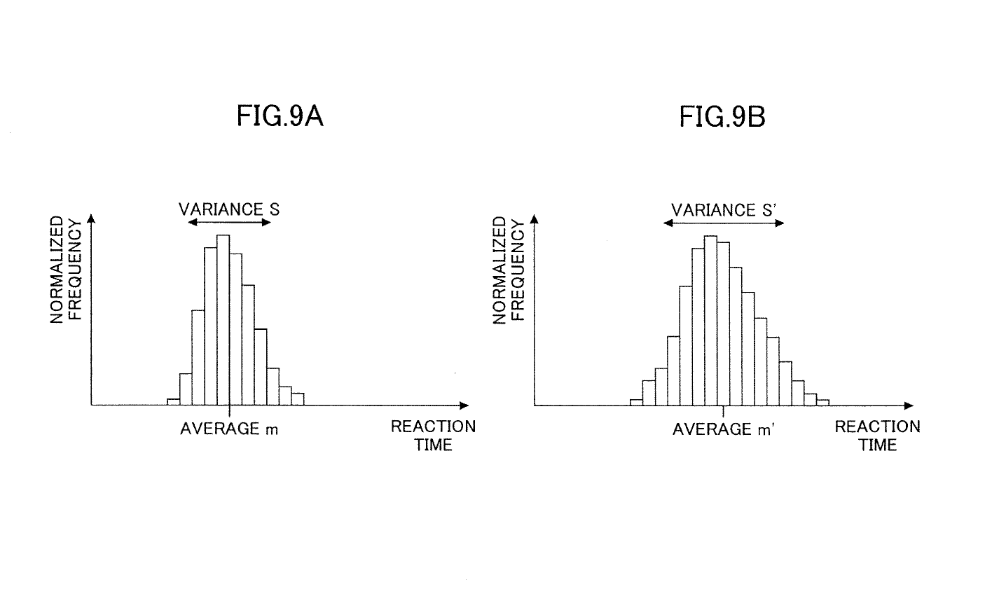

FIG. 9A and FIG. 9B are diagrams explaining an estimation way of the activity level based on the reaction time. FIG. 9A illustrates a normalized frequency of the reaction times of the visual inspection worker when the activity level of the visual inspection worker is high, and FIG. 9B illustrates a normalized frequency of the reaction times of the visual inspection worker when the activity level of the visual inspection worker is low. In FIGS. 9A and 9B, the normalized frequencies of the reaction times in a plurality of visual inspections with respect to the same parts are illustrated. The reaction times distribute over a predetermined range, as illustrated in FIGS. 9A and 9B.

As illustrated in FIG. 9A, when the activity level of the visual inspection worker is high, the reaction times are relatively short, and the variations thereof are small. On the other hand, as illustrated in FIG. 9B, when the activity level of the visual inspection worker is low, the reaction times are longer and the variations thereof are greater in comparison with a case where the activity level of the visual inspection worker is high. For example, an average value m′ of the reaction times in the case where the activity level of the visual inspection worker is low is longer than that an average value m of the reaction times in the case where the activity level of the visual inspection worker is high. Further, a variance S′ of the reaction times in the case where the activity level of the visual inspection worker is low is longer than that a variance S of the reaction times in the case where the activity level of the visual inspection worker is high. Thus, it can be understood that the average value or the variance of the reaction times can be used to estimate the reduction in the activity level of the visual inspection worker.

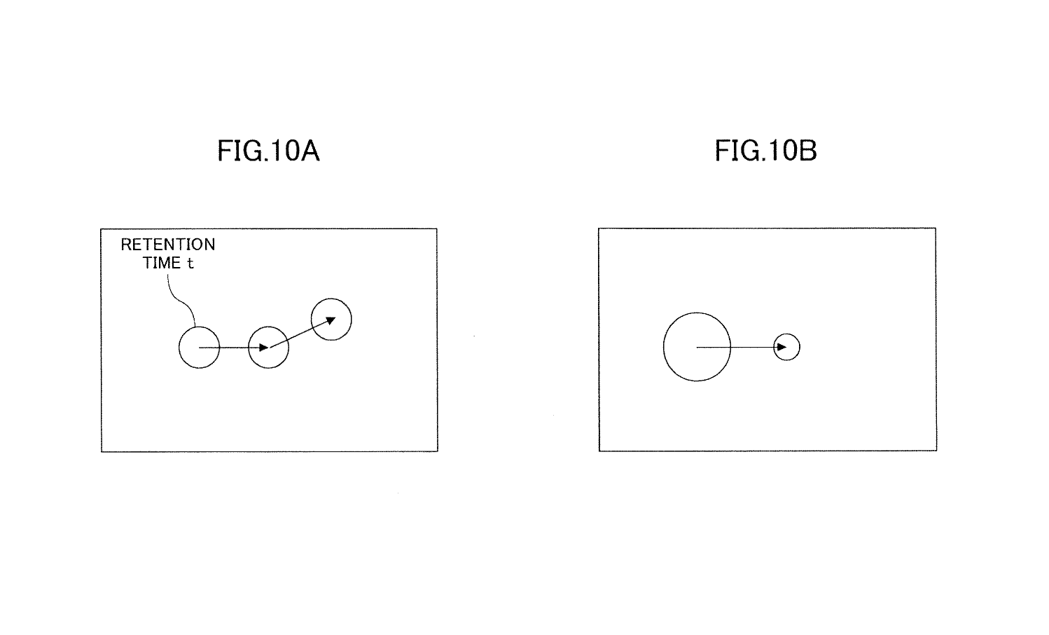

FIGS. 10A and 10B are diagrams explaining the estimation way of the activity level based on a motion of the vision line position. FIG. 10A schematically illustrates the motion of the vision line position of the visual inspection worker when the activity level of the visual inspection worker is high, and FIG. 10B schematically illustrates the motion of the vision line position of the visual inspection worker when the activity level of the visual inspection worker is low. In FIGS. 10A and 10B, the motion of the vision line position of the visual inspection worker on the inspection image with respect to the inspection image of a certain part. In FIG. 10, arrows represent the motion (motion vector) of the vision line position, circle marks indicate that the motion of the vision line position stops at the position (gazing point), and a radius of the circle mark indicates a stop period (retention time). In this way, the motion of the line of vision is expressed as a sequence of the gazing points (or the motion vectors connecting the gazing points) and the retention times at the gazing positions.

As illustrated in FIG. 10A, when the activity level of the visual inspection worker is high, portions required to be inspected in the inspection image are carefully checked in a steady manner. On the other hand, as illustrated in FIG. 10B, when the activity level of the visual inspection worker is low, the motion of the line of vision is retained, and the gazing points are also inaccurate. Thus, it can be understood that comparing the gazing number, the gazing positions, the retention times at the gazing positions, and the motion vectors with those in a normal state (i.e., when the activity level of the visual inspection worker is high) enables estimating the reduction in the activity level of the visual inspection worker.

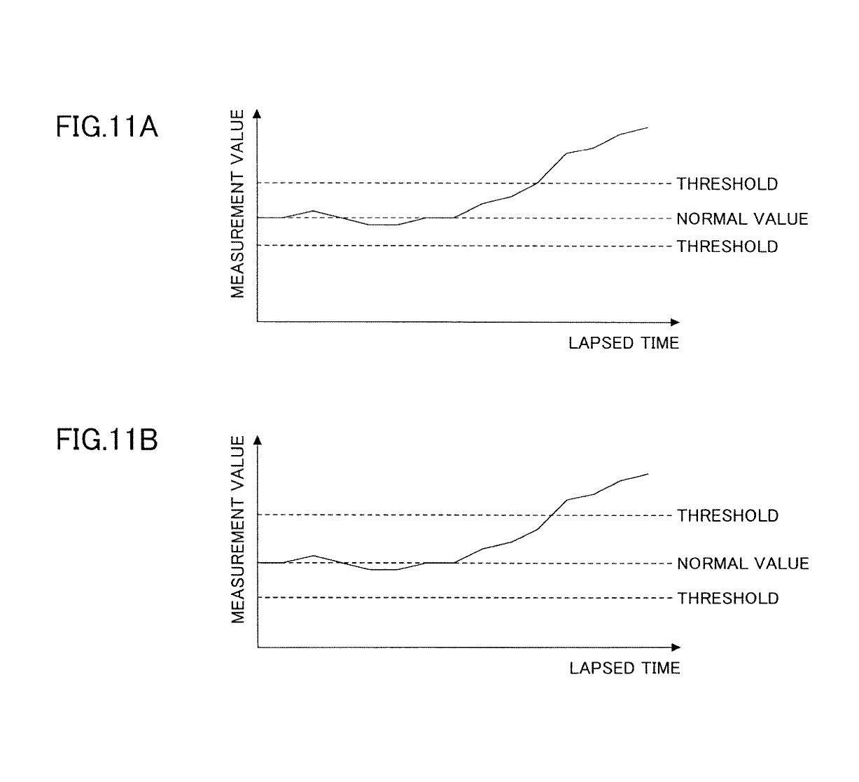

FIGS. 11A and 11B are diagrams illustrating an example of a change in a parameter (measurement value) indicative of the activity level of the visual inspection worker. In FIGS. 11A and 11B, the visual inspection worker differs between FIGS. 11A and 11B. The parameters indicative of the activity level of the visual inspection worker are the measurement value based on the reaction time of the visual inspection worker, the motion of the vision line position of the visual inspection worker, etc. In this case, a threshold is derived in advance based on the distribution of the measurement values obtained in a normal state and is stored. In this case, when the measurement value exceeds the threshold, it is determined that the activity level of the visual inspection worker has been reduced. The threshold is set to 3 sigma of a dispersion in the normal state. It is noted that the measurement values include variations among individuals, and thus it is effective to define the threshold on a visual inspection worker basis, as illustrated in FIGS. 11A and 11B. For this reason, for example, in step S500 in FIG. 5, the visual inspection worker is identified, and the threshold associated with the identified visual inspection worker may be used to determine whether the activity level has been reduced.

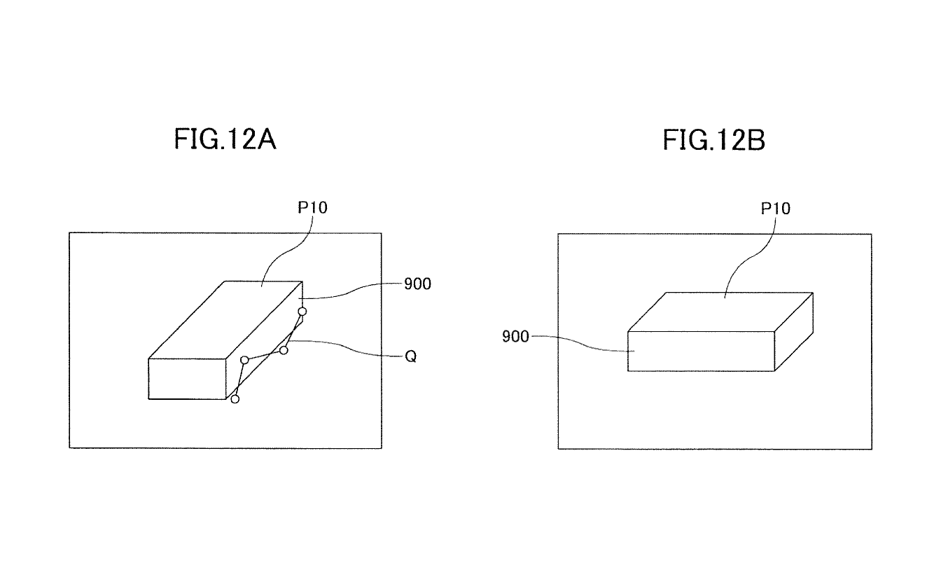

FIGS. 12A and 12B are diagrams explaining an example of a conversion process of the inspection image according to the feature portion of a part. FIG. 12A illustrates an initial view of a particular visual inspection target object P10 on the inspection image, and FIG. 12B illustrates a converted view. In FIGS. 12A and 12B, a rectangular frame represents an outline of the inspection image. In FIG. 12A, the detection result of the motion of the line of vision is illustrated with a reference symbol Q. The motion of the line of vision is represented with cross points between the line of vision and the inspection image. Such a detection result of the motion of the line of vision is illustrated for the sake of explanation, and thus is not displayed in the inspection image in fact.

According to the detection result of the motion of the line of vision illustrated in FIG. 12A, it can be seen that the visual inspection worker mainly check a side surface 900 of the visual inspection target object P10. In this case, the part feature analysis part 164 may determine that the side surface 900 of the visual inspection target object P10 is the feature portion. Accordingly, the inspection image conversion process part 184 may convert the view of the inspection image to be displayed such that the side surface 900 of the visual inspection target object P10 becomes a front side. Further, the inspection image conversion process part 184 may feature the contrast such that the side surface 900 of the visual inspection target object P10 is easily inspected, or may increase the brightness (see step S516 in FIG. 5). With this arrangement, the inspection image with increased visibility can be displayed, which expectedly enables the increase in the inspection accuracy and the decrease in the fatigue of the visual inspection worker. It is noted that such a conversion process may be performed from the inspection image of the next part which is the same as the visual inspection target object P10. It is noted that if the orientation of the camera 14 is required to be changed to convert the view, the inspection image may be captured again, or the orientation of the camera 14 may be changed from the next part which is the same as the visual inspection target object P10. Similarly, if the adjustment of the illumination is required to increase the brightness, the inspection may be captured again after the adjustment of the illumination, or the adjustment of the illumination is implemented from the next part which is the same as the visual inspection target object P10.

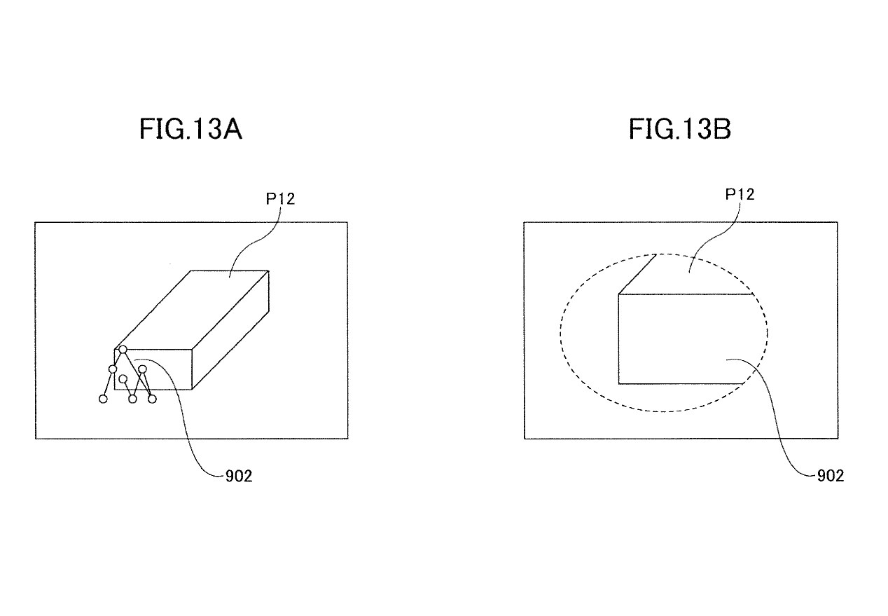

FIGS. 13A and 13B are diagrams explaining another example of the conversion process of the inspection image according to the feature portion of a part. FIG. 13A illustrates an initial displayed state of a particular visual inspection target object P12 on the inspection image, and FIG. 13B illustrates a converted displayed state.

According to the detection result of the motion of the line of vision illustrated in FIG. 13A, there is a portion 902 on which the line of vision of the visual inspection worker is focused for the increased gazing period. In this case, the part feature analysis part 164 may determine that the portion 902 of the visual inspection target object P12 is the feature portion. In response to this, the inspection image conversion process part 184 may enlarge the area of the portion 902 such that the inspection image conversion process part 184 remains only the portion 902 in which the gazing points are spread and masks other portions, as illustrated in FIG. 13B. With this arrangement, the inspection image including only the necessary portion can be displayed for the visual inspection worker, which expectedly enables the increase in the inspection accuracy and the decrease in the fatigue of the visual inspection worker. It is noted that, similarly, such a conversion process may be performed from the inspection image of the next part which is the same as the visual inspection target object P12. It is noted that if the position of the camera 14 is required to be changed to enlarge the area of the portion 902, the inspection image may be captured again, or the position of the camera 14 may be changed from the next part which is the same as the visual inspection target object P12.

In general, with respect to the visual inspection of print circuit boards, etc., the AOI performs the automatic inspection, and then the visual inspection with a human eye performed to inspect parts for which the automatic inspection cannot be applied because of the structures thereof or defect candidate portions for which the automatic inspection has difficulties to determine whether it is good or not. An apparatus that is used for the visual inspection is called as a “visual inspection support apparatus” which receives the position information of the inspection target portion on the substrate, captures the inspection target with predetermined capturing direction and scale, and displays the captured image as an inspection image on a monitoring device.

According to such an visual inspection, monotony but attention required work continues for a long time, which causes the reduction in the activity level due to the fatigue or the reduction in the concentration level, which in turn causes the inspection errors (overlooking the defect, etc.). According to a conventional visual inspection support apparatus, images of inspection targets are successively captured while moving a camera head and a stage, to display the captured images as they are on the monitoring screen, which inevitably causes the monotony of the work. Such monotonous work for a long time reduces the activity level (the concentration level or the arousal level) of the visual inspection worker, which causes the inspection errors, such as overlooking the defect, etc. On the other hand, keeping high attention or gazing for a long time not to overlook the defect causes the fatigue to be accumulated, which similarly causes the reduction in the work efficiency and the inspection accuracy.

According to the embodiment, as described above, it becomes possible to rhythmically display the inspection image that is easier for the visual inspection worker to inspect, which reduces the physical and mental loads of the visual inspection worker, thereby increasing the work efficiency and the inspection accuracy. The same parts are successively displayed by changing the display order, which makes it easy to determine the distinction between the normal part and the defect part, and enables reducing the overlooked defects. Further, the display timing for the inspection images are changed based on the concentration level and the fatigue level estimated from the measured action information of the visual inspection worker, which enables to keep the increased activity level of the visual inspection worker, and thus further increases the work efficiency.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention. Further, all or part of the components of the embodiments described above can be combined.

For example, according to the embodiment, when the activity level of the visual inspection worker is reduced, the display order or the display timing for the inspection images are changed. However, instead of this or in addition to this, a process of featuring the contrast or the brightness of the inspection images may be performed to promote the arousal of the visual inspection worker (see step S516 in FIG. 5) when the activity level of the visual inspection worker is reduced. Further, the image display area for the inspection image may be changed (see step S512 and step S514 in FIG. 5), when the activity level of the visual inspection worker is reduced.

Further, according to the embodiment, the display order and the display timing for the inspection images are changed when the activity level of the visual inspection worker is reduced; however, only one of the display order and the display timing for the inspection images may be changed.

Further, according to the embodiment, whether the activity level of the visual inspection worker is reduced is determined in such a binary manner; however, a stepwise determination in there or more steps may be performed. In this case, the display order, the display timing, the contrast, etc., for the inspection images may be changed stepwisely according to the activity level.

Further, according to the embodiment, the activity level of the visual inspection worker is determined based on the particular action information (the motion of the line of vision and the reaction time of the visual inspection worker); however, if another information can be obtained, such information may be used alternatively or additionally. Such information is related to the activity level, such as the number or frequency of eye closings of the visual inspection worker, a gesture (yawning, stretching, frowning a face, etc.) of the visual inspection worker, a body surface temperature, a pulse, etc., of the visual inspection worker.

Further, according to the embodiment, the visual inspection target object is an part; however, the visual inspection target object may be arbitrary as long as it can be visually inspected. For example, the visual inspection target object may wiring patterns on the substrate S, etc.

What is claimed is:

1. A visual inspection support apparatus, comprising:
a camera configured to obtain a plurality of different images capturing one or more visual inspection target objects;
an action information acquisition apparatus configured to obtain action information of a visual inspection worker; and
a processing device configured to determine an activity level of the visual inspection worker based on the action information, and change a way of displaying the images based on a determination result of the activity level of the visual inspection worker.

2. The visual inspection support apparatus of claim 1, wherein the processing device changes the way of displaying the images for the visual inspection worker upon the activity level of the visual inspection worker being reduced.

3. The visual inspection support apparatus of claim 1, wherein changing the way of displaying the images includes at least one of changing an order in which the images are displayed, changing a display timing of the images, changing a contrast of the images, changing an area to be displayed in the images, and changing a brightness of the images.

4. The visual inspection support apparatus of claim 2, wherein changing the way of displaying the images includes changing an order in which the images are displayed, and
the processing device changes, upon the activity level of the visual inspection worker being reduced, the order from a first order, in which the images related to the same visual inspection target objects or the same types of the visual inspection target objects are successively displayed, to a second order different from the first order.

5. The visual inspection support apparatus of claim 4, wherein the second order corresponds to an order in which the images are captured.

6. The visual inspection support apparatus of claim 2, wherein changing the way of displaying the images includes changing a display timing of the images, and
the processing device changes, upon the activity level of the visual inspection worker being reduced, an interval of switching between the images from a constant value to a variable value.

7. The visual inspection support apparatus of claim 1, wherein the action information of the visual inspection worker includes at least one of a reaction time between a timing of displaying one of the images and a timing of an input of an inspection result by the visual inspection worker, and a motion of a line of vision of the visual inspection worker during a period in which one of the images is displayed.

8. The visual inspection support apparatus of claim 2, wherein the action information of the visual inspection worker includes a reaction time between a timing of displaying one of the images and a timing of an input of an inspection result by the visual inspection worker, and
the processing device determines that the activity level of the visual inspection worker has been reduced when an average value or a variance of the reaction times exceeds a predetermined threshold.

9. The visual inspection support apparatus of claim 2, wherein the action information of the visual inspection worker includes a motion of a line of vision of the visual inspection worker during a period in which one of the images is displayed, and
the processing device determines that the activity level of the visual inspection worker has been reduced when a retention time of the motion of the line of vision exceeds a predetermined threshold.

10. The visual inspection support apparatus of claim 8, wherein the predetermined threshold is varied on a visual inspection worker basis.

11. The visual inspection support apparatus of claim 9, wherein the predetermined threshold is varied on a visual inspection worker basis.

12. The visual inspection support apparatus of claim 1, wherein the action information of the visual inspection worker includes a motion of a line of vision of the visual inspection worker during a period in which one of the images is displayed, and
the processing device identifies a feature portion of the visual inspection target objects based on the motion of the line of vision.

13. The visual inspection support apparatus of claim 12, wherein the processing device performs at least one of changing a contrast of an image area related to the feature portion of the visual inspection target objects, enlarging the image area related to the feature portion of the visual inspection target objects, and increasing a brightness of the image area related to the feature portion of the visual inspection target objects.

14. The visual inspection support apparatus of claim 1, wherein the images are obtained by capturing the visual inspection target objects, respectively.

15. The visual inspection support apparatus of claim 14, wherein the images are obtained by capturing the different visual inspection target objects installed on the same substrate.

16. The visual inspection support apparatus of claim 1, wherein the images are obtained by capturing the visual inspection target objects installed on the same substrate.

17. A visual inspection support program causing a computer to perform:
obtaining a plurality of different images capturing one or more visual inspection target objects;
obtaining action information of a visual inspection worker; and
determining an activity level of the visual inspection worker based on the action information, and changing a way of displaying the images based on a determination result of the activity level of the visual inspection worker.

18. A method of supporting a visual inspection, comprising:
obtaining a plurality of different images capturing one or more visual inspection target objects;
obtaining action information of a visual inspection worker; and
determining an activity level of the visual inspection worker based on the action information, and changing a way of displaying the images based on a determination result of the activity level of the visual inspection worker.
